(19) United States
(12) Patent Application Publication
(10) Pub. No.: US 2010/0014283 A1
(43) Pub. Date: Jan. 21, 2010

(54) PORTABLE LAMP

(76) Inventor: Camisha Gates, Chandler, AZ (US)

Correspondence Address: MICHAEL RIES, 318 PARKER PLACE, OSWEGO, IL, 60543, US

(21) Appl. No.: 12/176,515

(22) Filed: Jul. 21, 2008

(51) Int. Cl. F21L 4/00

(52) U.S. Cl. 362/186

(57) ABSTRACT

Disclosed is a portable lamp which may be conveniently carried by a person from one place to another in a room for lighting an area of the room. The portable lamp includes a support member, an electrical socket, a power source and an electrical switch. The support member includes a top end portion configured with the electrical socket, and a bottom end portion configured with the power source. The electrical socket is capable of receiving a light source. The power source is electrically coupled to the electrical socket. The electrical switch is configured on at least one of the top end portion and the bottom end portion of the support member and electrically coupled to the power source for operating the light source.

### FIELD OF THE INVENTION

The present invention relates generally to lighting devices, and, more particularly, to a portable lamp which may be conveniently carried for lighting a working area.

### BACKGROUND OF THE INVENTION

Wall mounted bulbs and tube-lights are the most commonly used sources of light in a working area, for example, in households and offices. Generally, bulbs and tube-lights are used for lighting main living area or working area of a room, whereas certain portions of the room remain comparatively darker, such as corners of the room. Accordingly, most of the people use table lamps or floor lamps (hereinafter referred to as lamps) for lighting the corners of the room.

Conventional lamps are operated mostly on Alternating Current (AC) power and are configured with a cord for receiving power from an electrical power socket. Sometimes, working areas may not have suitably located electrical power sockets for providing an electric power supply to the lamps. For example, most of the houses lack electrical power sockets in proximity to a floor and the corners of the room. In such instances, the conventional lamp needs to be connected to a distantly-located electrical power socket by extension cords. As a result, the extension cords may run across the floor or along walls of the room, thereby causing discomfort to a person moving around in the room. Moreover, use of the extension cords in such a manner affects the aesthetic look of the room.

Accordingly, there exists a need for a portable lamp that may be conveniently carried from one place to another for lighting a working area in a room. Moreover, there exists a need for a portable lamp that may be utilized for lighting poorly lighted areas of a room without the need of an extension cord.

### SUMMARY OF THE INVENTION

In view of foregoing disadvantages inherent in the prior art, the general purpose of the present invention is to provide a portable lamp configured to include all the advantages of the prior art, and overcome the drawbacks inherent therein.

Accordingly, an object of the present invention is to provide a portable lamp which may be conveniently carried from one place to another in a room for lighting a working area of the room.

Another object of the present invention is to provide a portable lamp which may be utilized for lighting poorly lighted areas of a room without the need of an extension cord or a nearby electrical outlet and for use in areas of a room that otherwise would be difficult or inefficient due to the need for power cords.

In light of the above objects, in one aspect of the present invention, a portable lamp is disclosed. The portable lamp includes a support member, an electrical socket, a power source and an electrical switch. The support member includes a top end portion and a bottom end portion. The electrical socket is configured at the top end portion of the support member. The electrical socket is capable of receiving a light source therein. The power source is configured at the bottom end portion of the support member. The power source is electrically coupled to the electrical socket. The electrical switch is configured on at least one of the top end portion and the bottom end portion of the support member. The electrical switch is electrically coupled to the power source for operating the light source.

In another aspect of the present invention, the portable lamp further includes a shade configured to be received on the top end portion of the support member for enclosing the light source.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 illustrates an exploded front view of a portable lamp, in accordance with an exemplary embodiment of the present invention;

FIG. 2 illustrates an assembled front view of the portable lamp of FIG. 1, in accordance with an exemplary embodiment of the present invention; and

FIG. 3 illustrates a partial bottom perspective view of the portable lamp, in accordance with an exemplary embodiment of the present invention.

Like reference numerals refer to like parts throughout the description of several views of the drawings.

### DETAILED DESCRIPTION OF THE INVENTION

The exemplary embodiments described herein detail for illustrative purposes and are subject to many variations in structure and design. It should be emphasized, however, that the present invention is not limited to a portable lamp, as shown and described. It is understood that various omissions and substitutions of equivalents are contemplated as circumstances may suggest or render expedient, but these are intended to cover the application or implementation without departing from the spirit or scope of the claims of the present invention. Also, it is to be understood that the phraseology and terminology used herein is for the purpose of description and should not be regarded as limiting.

The terms “a” and “an” herein do not denote a limitation of quantity, but rather denote the presence of at least one of the referenced item.

The present invention provides a portable lamp which may be conveniently carried by a person from one place to another in a room for lighting an area of the room. Specifically, the portable lamp may be used for lighting a main living area or working area of the room. Further, the portable lamp is capable of being used for lighting an area of the room that lacks power outlets, such as electrical power sockets.

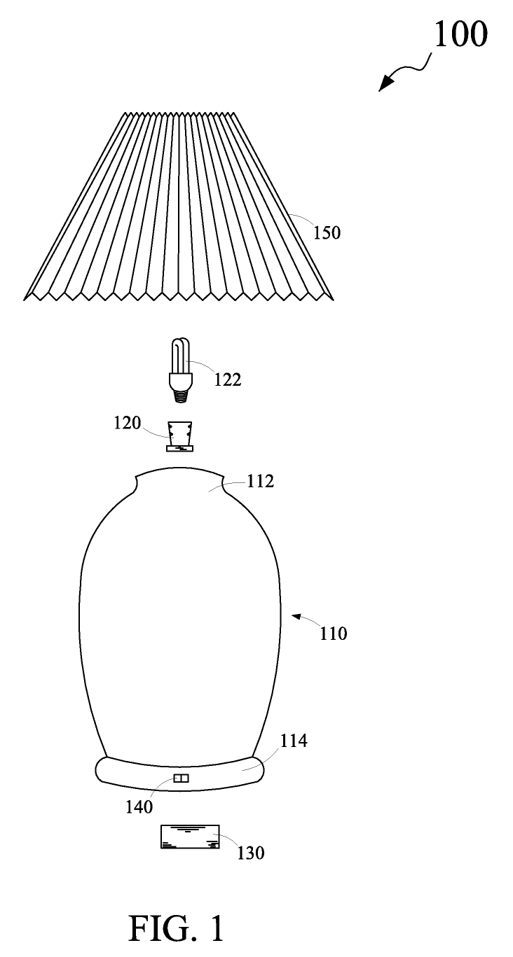

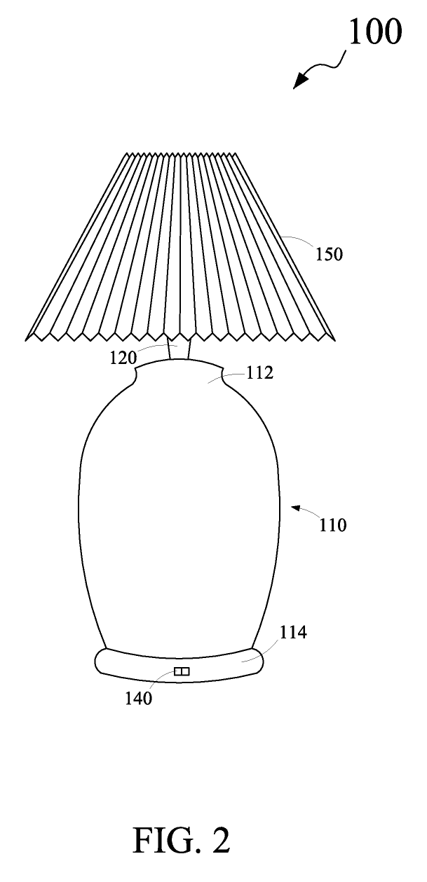

Referring to FIGS. 1 and 2, front views of a portable lamp 100 are illustrated, in accordance with an exemplary embodiment of the present invention. More specifically, FIG. 1 illustrates an exploded front view of the portable lamp 100, and FIG. 2 illustrates the assembled front view of the portable lamp 100. The portable lamp 100 includes a support member 110, an electrical socket 120, a power source 130 and an electrical switch 140.

The support member 110 includes a top end portion 112 and a bottom end portion 114. In the present embodiment, the support member 110 is depicted as a pot-shaped structure for the purpose of illustration only. However, it will be evident to a person skilled in the art that the support member 110 may be configured to have variety of structures which enables in providing an aesthetically pleasing look to the portable lamp 100. Further, in one embodiment of the present invention, the support member 110 is composed of a light-weight material, such as a plastic material. The support member may also be composed of material such as, but not limited to, ceramic, iron, glass and metal.

The electrical socket 120 is configured at the top end portion 112 of the support member 110. The electrical socket 120 is capable of receiving a light source 122. In the present embodiment, the light source 122 is depicted as an incandescent light bulb for the purpose of illustration only. However, it will obvious to a person skilled in the art that the light source 122 may be any other light source. For example, the light source 122 may include at least one Light Emitting Diode (LED). More specifically, the light source 122 may be includes a plurality of LEDs capable of providing sufficient light for illuminating the area of the room.

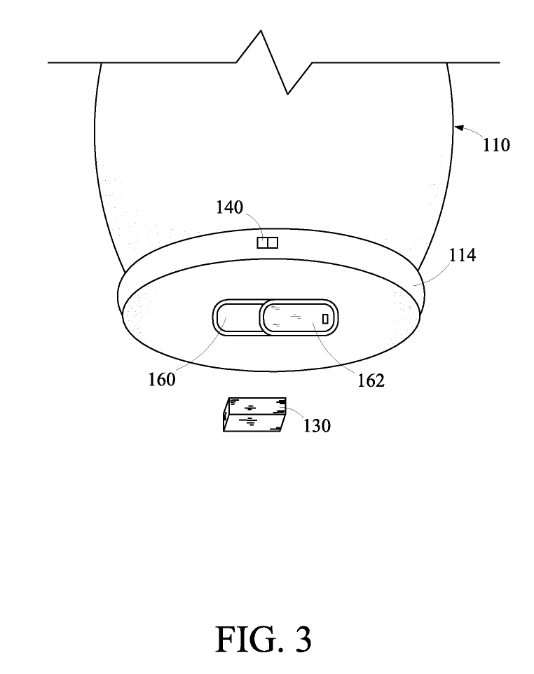

The electrical socket 120 is electrically coupled to the power source 130 for transferring an electrical power from the power source 130 to the light source 122. The power source 130 is configured at the bottom end portion 114 of the support member 110. The configuration of the power source 130 at the bottom end portion 114 is further explained in detail in conjunction with FIG. 3. Further, it will be evident to person skilled in the art that the light source 122 is electrically coupled to the power source 130 by suitable connection means, such as wires (not shown), control circuit (not shown), and the electrical switch 140. The suitable connection means further includes the electrical socket 120, receiving the light source 122. More specifically, the electrical socket 120 is an incandescent bulb holder capable of receiving the light source 122.

The electrical switch 140 may be configured on at least one of the top end portion 112 and the bottom end portion 114 of the support member 110. In the present embodiment, the electrical switch 140 is illustrated to be configured on the bottom end portion 114. However, it will be apparent to a person skilled in the art that the electrical switch 140 may be configured at any suitable portion of the support member 110. Further, the electrical switch 140 is electrically coupled to the power source 130 for operating the light source 122. More specifically, the electrical switch 140 is adapted to illuminate and extinguish the light source 122.

The portable lamp 100 further includes a shade 150 configured to be received on the top end portion 112 of the support member 110. More specifically, the shade 150 may be coupled to the electrical socket 120 by suitable coupling means, such that the shade 150 encloses the light source 122, as shown in FIG. 2.

In the present embodiment, the shade 150 is depicted as a hollow frustum-shaped structure for the purpose of illustration only. However, it will be apparent to a person skilled in the art that the shade 150 may be configured to have a variety of structures which enables in providing an aesthetically pleasing look to the portable lamp 100.

Referring to FIG. 3, a partial bottom perspective view of the portable lamp 100 is illustrated, in accordance with an exemplary embodiment of the present invention. As shown in FIG. 3, the bottom end portion 114 of the support member 110 includes a cavity 160 and a cover 162. The cavity 160 is configured to receive the power source 130 therein. Moreover, the cover 162 is adapted to close the cavity 160. More specifically, the cover 162 is capable of being slidably moved forward and backward for opening and closing the cavity 160.

In one embodiment of the present invention, the power source 130 includes at least one battery. More specifically, the power source 130 may include a pack of batteries for providing power to the portable lamp 100. Further, the at least one battery may be a rechargeable battery such as an AA rechargeable battery, a rechargeable AAA battery and the like. Alternatively, the at least one battery may be a non-rechargeable battery. In another embodiment of the present invention, the power source 130 may be configured to pull power from a nearby radio frequency source. More specifically, the portable lamp 100 may further include a receiver (not shown) adapted to receive radio frequencies for providing power to the portable lamp 100. The receiver may be operatively coupled to the light source 122 for providing power thereto. Further, the term “radio frequency source” used herein refers to an electrical device capable of generating radio frequencies. In one embodiment of the present invention, the radio frequency source may be mounted on a wall in proximity to the portable lamp 100.

Preferably, the portable lamp, explained in conjunction with FIGS. 1-3 is a designer lamp that is operated by means of a power source, for example, a battery. The use of the battery for operating the portable lamp avoids a need for a cord for receiving an electrical power from an electrical power socket, thereby enabling the portable lamp to be used in areas of the room which lacks the electrical power sockets. Moreover, the portable lamp may be carried to poorly lighted areas, such as corners of the room for providing illumination. Further, the use of battery for operating the portable lamp enables the portable lamp to be used during power outages. The portable lamp may be provided with an additional power source for operating the portable lamp, thereby providing uninterrupted power to the portable lamp for a substantial period. The portable lamp of the present invention is lightweight and easily portable. In a preferred embodiment of the present invention, the portable lamp may be configured to have a height ranging from about 2 feet to 5 feet depending upon the application thereof.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The embodiments were chosen and described in order to best explain the principles of the present invention and its practical application, and to thereby enable others skilled in the art to best utilize the present invention and various embodiments with various modifications as are suited to the particular use contemplated. It is understood that various omissions and substitutions of equivalents are contemplated as circumstances may suggest or render expedient, but these are intended to cover the application or implementation without departing from the spirit or scope of the claims of the present invention.

What is claimed is:

1. A portable lamp comprising:
a support member having a top end portion and a bottom end portion;
an electrical socket configured at the top end portion of the support member, the electrical socket capable of receiving a light source;
a power source configured at the bottom end portion of the support member, the power source electrically coupled to the electrical socket; and
an electrical switch configured on at least one of the top end portion and the bottom end portion of the support member, the electrical switch electrically coupled to the power source for operating the light source.

2. The portable lamp of claim 1, further comprising a shade configured to be received on the top end portion of the support member for enclosing the light source.

3. The portable lamp of claim 1, wherein the light source is an incandescent light bulb.

4. The portable lamp of claim 1, wherein the light source comprises at least one Light Emitting Diode (LED).

5. The portable lamp of claim 1, wherein the power source comprises at least one battery.

6. The portable lamp of claim 5, wherein the at least one battery is a rechargeable battery.
